(19) United States
(12) Patent Application Publication
(10) Pub. No.: US 2025/0363444 A1
(43) Pub. Date: Nov. 27, 2025

(54) Secure Access to a Location

(71) Applicant: Glue AB, Stockholm (SE)

(72) Inventors: James Belcher, Stockholm (SE); Lawrence Wallace, Stockholm (SE)

(21) Appl. No.: 18/872,003

(22) PCT Filed: Jun. 7, 2023
(86) PCT No.: PCT/EP2023/065238

§ 371 Date: Dec. 5, 2024

(30) Foreign Application Priority Data
Jun. 7, 2022 (GB) 2208346.3
Feb. 9, 2023 (GB) 2301826.0

(51) Int. Cl. G06Q 10/0833; G06F 16/955; G06Q 10/0834; H04W 4/14

(52) U.S. Cl. CPC G06Q 10/0833; G06F 16/955; G06Q 10/0834; H04W 4/14

(57) ABSTRACT

Computer implemented method and system for managing a secure delivery to a property. As part of a transaction, the system receives from a first user a selection of a courier entity, and the courier entity schedules delivery to the property. The system: provides the first user with an option for using an enhanced delivery mode, receives confirmation of the selected mode; transmits to the courier entity confirmation of the selected mode; detects, using a mobile application, location of a mobile device of a second user; determines that the location of the mobile device is within a predetermined distance of the property; receives from the mobile application confirmation of delivery to the property; deletes a first set of sensitive data related to the property and/or the delivery; transmits to the user details of the delivery; and deletes a second set of sensitive data related to the property and/or the delivery.

### CROSS-REFERENCE TO RELATED APPLICATIONS

This Application is a Section 371 National Stage Application of International Application No. PCT/EP2023/065238, filed Jun. 7, 2023, and published as WO 2023/237607 A1 on Dec. 14, 2023, in English, which claims priority to and the benefit of Great Britain Patent Application No's. 2208346.3, filed Jun. 7, 2022, and 2301826.0, filed Feb. 9, 2023, the contents of which are incorporated herein by reference in their entireties.

### FIELD OF THE INVENTION

The present invention relates to a system and method for providing access to a location securely and in particular, to enable access to a property by a delivery courier without compromising security.

### BACKGROUND OF THE INVENTION

The ability to order products and services electronically and have them delivered has created a huge online industry, especially for groceries and retail goods. However, such products may be delivered at unknown times or may be delayed. Many people are out of their homes when products are delivered and need to have them redelivered when they are home or are restricted to online sites that can provide a short time window for deliveries. However, as online deliveries become more popular, many delivery slots, especially in the evenings and at weekends, become unavailable.

Waiting in for deliveries is therefore less than ideal. Some existing solutions involve providing lockers accessed by codes either at residential locations or in central facilities, so that items can be picked up at a convenient time. However, such solutions are not always appropriate, especially for food or other perishable items.

Leaving a property unlocked for a delivery courier is not an option as this represents a significant security risk.

Smart locks may be fitted that allow third parties to enter a property under certain situations. However, not all properties have a smart lock fitted or if they do then the third party (e.g., a delivery company or driver) may not have access to the system linked to that particular smart lock.

Therefore, there is required a method and system that overcomes these problems.

### SUMMARY OF THE INVENTION

Against this background and in accordance with a first aspect there is provided a system and method as described in the appended claims.

The methods described above may be implemented as a computer program comprising program instructions to operate a computer. The computer program may be stored on a computer-readable medium, including a non-transitory computer-readable medium.

The computer system may include a processor or processors (e.g. local, virtual or cloud-based) such as a Central Processing Unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE DRAWINGS

FIG. 1 is a diagram illustrating a computer system according to an exemplary aspect of the disclosure;

FIG. 2 is a flowchart of a method by which a user enters their delivery details;

FIG. 3 shows a screenshot from a mobile application of a customer choosing a courier at checkout who is a registered AnyLock partner, according to an aspect of the disclosure;

FIG. 4 is a screenshot from a mobile application of the customer choosing a courier partner (courier entity) who has completed a checkout integration whereby AnyLock is an electable option at checkout;

FIG. 5 shows screenshots from a mobile application of the courier partner sending an SMS to the customer offering an AnyLock upgrade;

FIG. 6 shows a screenshot of a mobile application where the customer lands on the AnyLock web module and is presented with their delivery details as well as the option to choose a specific type of AnyLock delivery method;

FIG. 7 shows screenshots from the mobile application illustrating the customer enters delivery details against one of the four AnyLock delivery methods;

FIG. 8 shows screenshots from the mobile application after the customer has completed AnyLock delivery details;

FIG. 9 shows a screenshot from a mobile application illustrating the courier opening the Glue Driver app and choosing the relevant delivery;

FIG. 10 shows a screenshot from the mobile application of the Glue platform completing verification and allowing the delivery driver to elect to start the delivery Upon successful validation;

FIG. 11 shows a screenshot of the mobile application where the delivery driver starts the delivery;

FIG. 12 shows a series of screenshots from the mobile application where the driver is guided through the delivery;

FIG. 13 shows a series of screenshots from the mobile application where the customer receives notification that the AnyLock delivery is complete; and

FIG. 14 is a schematic diagram of the system for implementing the method.

### DETAILED DESCRIPTION OF ILLUSTRATIVE EMBODIMENTS

There are many highly satisfied smart lock customers who make regular use of the services such as the Glue InHome service, whereby they are able to receive delivery of goods and services when they are not at their property. However, it is recognised that an upfront cost for a smart lock is for many may be a prohibitive entry barrier to receiving delivery services, such as those provided by InHome.

Therefore the described solution allows a wider group of customers to enjoy the benefit of services, such as InHome deliveries, without the requirement to purchase a Smart Lock. The following user statement reflects a problem at a high level:

A single, simple end user story may be stated as:

As an end user I want to be able to receive goods and services into my home when I am not at home, in a secure and trustworthy manner without having to purchase a smart lock.

Further sub user stories relating to the secure and trustworthiness of the solution include:
I want the information I provide relating to a key location or pin code to be received and stored in a secure manner.
I want the information I provide to only be made available to the person authorised to enter my home, when they are near my home and at the time they are due to enter my home.
I want the information I provide to be made available only for an amount of time necessary for the authorised person to enter my home and execute the task the person was authorized for.
I want to see proof that the authorised person entered my home only for the purpose I authorised.
I want to see proof that the authorised person left my home in a secure state after they left.
After the authorised person leaves my home, I want the information I provided (i.e., information provided for the purpose of entering the home) to be deleted.

### Summary of the System and Method:

The following points details example aspects of the solution (described throughout this disclosure as AnyLock) from the perspective of an end user:
1. End users are able to provide the system or server (described as Glue throughout) with details in a secure manner relating to:
   1. The location where a key might safely be hidden;
   2. the location for, and pin code for a key safe where a key is stored;
   3. a neighbour who has a key and a verbal password which is required for the neighbour to release they key; and/or
   4. the pin code to an existing pin code based door lock.
2. Other methods of granting AnyLock access include:
   1. Access through a smart lock mobile app for a connected electronic door lock (Smart Lock);
   2. A smart card (RFID) with a code for a smart card reader door lock;
   3. A QR code generated by the AnyLock Platform to the smart lock linked QR Code reader;
   4. Access using a biometric profile (face or fingerprint) of AnyLock platform pre-registered, id verified third party persons giving access though biometric controlled electronic connected door locks (Smart Lock); and
   5. Real time: through ringing and presenting a QR code on the smart phone of the delivery person generated by the AnyLock platform and specifically generated for this delivery contract to the door bell camera or other outdoor cameras.
3. The end user (first user) enters this information as data points into either the AnyLock web module or the AnyLock screens within the Glue app.
4. The end user provides this information either during the checkout process with an online merchant, or at the invitation of Glue or the courier/service provision partner at some point between checkout and the scheduled delivery/provision of service.
5. This information is stored securely on the Glue platform and surfaced to an authorised courier/service provision partner at the point when the courier/service provision partner is physically near to the End User's home and within the scheduled delivery/service provision time.
6. The information is surfaced using the Glue driver app (for a second user) or screens within courier/service provision partner's existing app which integrate with the Glue platform.
7. Video recording automatically begins at the point that the information is made available to the delivery/service provision partner and ends when they have left the end user's home in a secure state.
8. The courier/service provision partner has the opportunity to inform Glue whether the delivery has been successful or not, and if not, why not.
9. The end user is informed immediately after the delivery whether it has been a success or not, and if not, why not.
10. The end user has the ability to view the video recording as soon as possible after a successful delivery has occurred.
11. In scenarios where a physical key is retrieved in order to gain entry, the end user enters details as to where they wish the key to be left after the delivery and for this information is made available to the courier/service provision partner.

### Additional Notes

The definition of end user (first user) in the above points includes but is not limited to home owners, renters, leasers, co-habitants in single and multi tenanted dwellings.

The definition of a courier/service provision partner (courier entity) includes but is not limited to, merchants, delivery company, service provision company etc. and their AnyLock registered employees and or subcontractor, in the business of delivery of packets, goods and in-home services (cleaning, repair & maintenance, pet care, plant care, child car, elderly care and first time responders in case of emergency) when nobody is at home.

The method used to determine that the courier/service provision partner is located close to the end user's home in order to authorise the surfacing of AnyLock information includes:
Calling upon the end user's mobile device geo-location services;
Using fixed and satellite internet services; and/or
Bluetooth connection to a smart device.

Video recording may be automatically triggered at the point that AnyLock information is surfaced to the courier/service provision partner. The method to complete this recording includes:
Using the camera on the courier/service provision partner's mobile device;
Indoor surveillance cameras;
Outdoor surveillance cameras; and/or
Smart doorbells

The AnyLock service is a free or paid for service either by the end user or the courier/service provision partner.
1. Methods do exist whereby couriers and merchants request additional information that lead to a delivery packet being left in a safe place or with a neighbour, but not in the home. Even in this example AnyLock differs in that:
a. Unlike existing methods, the sensitive information relating to an InHome delivery is not provided to the courier/merchant. Instead, it is provided to Glue, is held securely on the Glue platform or server and is only available to the courier/delivery partner at the point they are close to the end user's home and within the scheduled delivery window.
b. At a suitable point in time after the delivery is complete (e.g., default to 29 days) the sensitive information is deleted.
2. As earlier stated, the relevant AnyLock information is only surfaced to the courier/delivery partner when they are close to the customers home and within the scheduled delivery window. This multi-point credential check is highly secure.
3. Once saved by the end user the information cannot be edited at any point as courier API access is read only. It can only be deleted and resubmitted by the end user if required. Immediately after a successful delivery all sensitive AnyLock information is automatically deleted and all non-sensitive information is deleted, for example 29 days later.
4. Unlike any other delivery method known to Glue (other than Glue's other patented methods), all InHome deliveries are automatically video recorded, and the video recording is available to view by the end user.
5. In the event that a physical key is used to complete the InHome delivery, the end user has the option of specifying where the key should be left after the delivery. Be it with the parcel, posted through the letterbox or back where it was originally located.

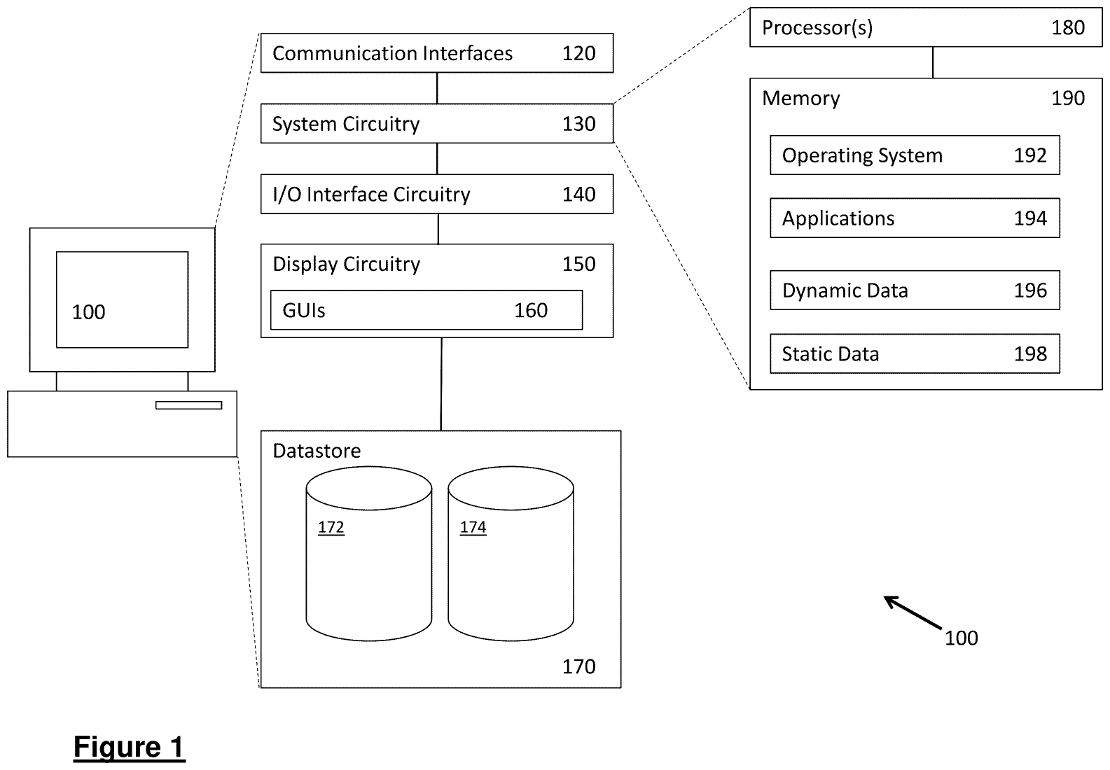

As shown in FIG. 1, a computer system 100 includes a number of components including communication interfaces 120, system circuitry 130, input/output (I/O) circuitry 140, display circuitry and interfaces 150, and a datastore 170. The system circuitry 120 can include one or more processors or CPUs 180 and memory 190. The system circuitry 130 may include any combination of hardware, software, firmware, and/or other circuitry. The system circuitry 130 may be implemented, with one or more systems on a chip (SoC), application specific integrated circuits (ASIC), microprocessors, and/or analog and digital circuits.

The display circuitry may provide one or more graphical user interfaces (GUIs) 160 and the I/O interface circuitry 140 may include touch sensitive or non-touch displays, sound, voice or other recognition inputs, buttons, switches, speakers, sounders, and other user interface elements. The I/O interface circuitry 140 may include microphones, cameras, headset and microphone input/output connectors, Universal Serial Bus (USB) connectors, and SD or other memory card sockets. The I/O interface circuitry 140 may further include data media interfaces (e.g., a CD-ROM or DVD drive) and other bus and display interfaces.

The memory 190 may include volatile (RAM) or non-volatile memory (e.g., ROM or Flash memory). The memory may store the operating system 192 of the computer system 100, applications or software 194, dynamic data 196, and/or static data 198. The datastore or data source 170 may include one or more databases 172, 174 and/or a file store or file system, for example.

The method and system may be implemented in hardware, software, or a combination of hardware and software. The method and system may be implemented either as a server comprising a single computer system or as a distributed network of servers connected across a network. Any kind of computer system or other electronic apparatus may be adapted to carry out the described methods.

### Example Method and System

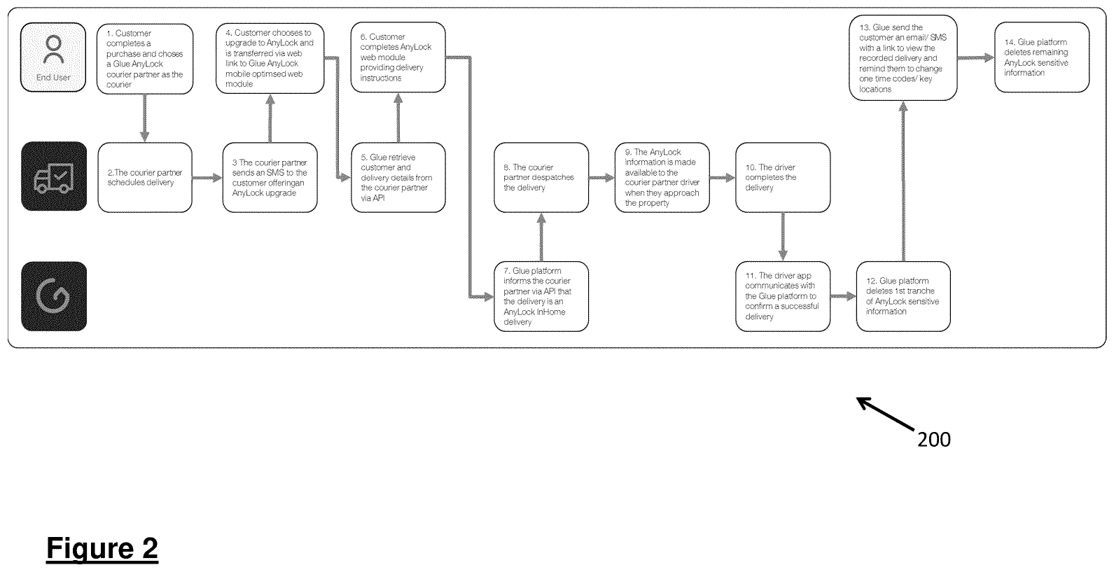

FIG. 2 shows a flowchart of a method 200 by which the user enters their delivery details, the details are surfaced to the delivery driver and proof of the delivery is provided to the user is considered unique. The following sections covers this method 100 in more detail (numbers in FIG. 2 correspond with the following numbered steps):

1. FIG. 3 shows a screenshot from a mobile application of a customer choosing a courier at checkout who is a registered AnyLock partner. The customer completes a purchase and choses standard home delivery from a Glue AnyLock courier partner.

The customer completes an online purchase with any merchant who either uses a Glue AnyLock courier partner as their exclusive delivery partner or as an optional delivery partner. In the latter instance, the customer chooses the Glue AnyLock courier partner to deliver their purchase.

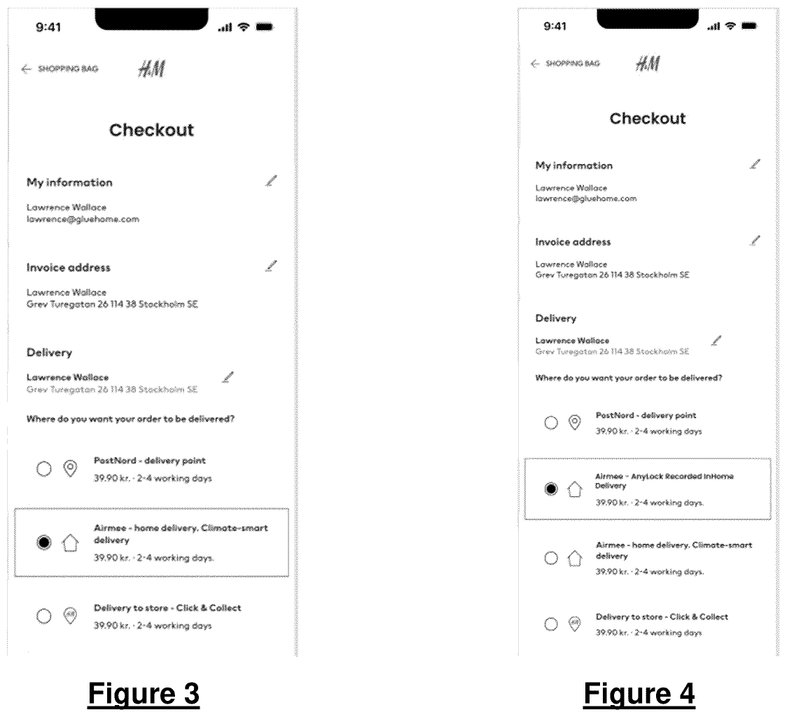

2. FIG. 4 shows a screenshot from a mobile application of the customer (first user) choosing a courier partner (courier entity) who has completed a checkout integration whereby AnyLock is an electable option at checkout. The courier partner schedules the delivery. Information within the delivery schedule may include a delivery time window (e.g., start and end time or start time and duration) within which the delivery must take place. If the courier arrives outside of this time window, then they will not be sent information enabling them to complete the delivery (see step 6 below). This may be known as access window clamping. End users are invited to provide their elected time window when approving AnyLock deliveries. The courier partner receives details of the delivery from the merchant including customer address and personal details such as telephone number and email address. The courier partner schedules a time and date for the delivery.

Note that this process assumes that the courier/merchant has not completed a more complicated integration with Glue and therefore does not show the option of an AnyLock delivery in the web checkout flow. It is designed this way to ensure the least possible build effort for the merchant/courier. As an enhancement the AnyLock design includes this integration option.

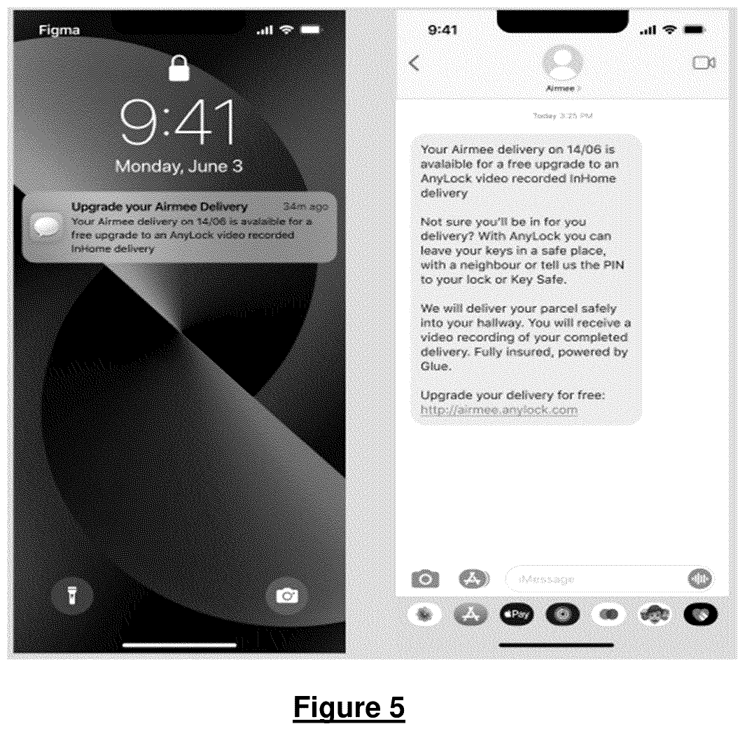

3. FIG. 5 shows screenshots from a mobile application of the courier partner sending an SMS to the customer offering an AnyLock upgrade.

Once the courier partner has a known delivery slot, they send an SMS to the customer requesting that they confirm their delivery. Included in this SMS is an option to upgrade to an AnyLock InHome delivery (an enhanced delivery mode).

If the customer chooses to remain with the courier partner's standard home delivery, the customer is taken to the courier's own site to confirm the delivery or confirms the delivery by text message (or the customer may simply do nothing and the delivery remains a standard one by default, i.e., unenhanced delivery mode). If the customer chooses this path the AnyLock journey ends.

If the customer chooses an AnyLock InHome delivery, they click on a web link in the SMS which takes them to the AnyLock Web Module (preferably mobile optimised).

The courier partner includes a tracking ID (or hash thereof) relating to the specific customer's delivery in the web link.

4. The customer may choose to upgrade to AnyLock and is transferred via web link to Glue AnyLock mobile optimised web module.

The first screen of the AnyLock module may be branded as per the courier partner and presents details of the customer delivery.

This is possible as the tracking ID embedded within the AnyLock web module URL sent to the customer (see FIG. 5, right side), which allows the Glue platform to determine the identity of the courier and the data required to access the customer delivery details.

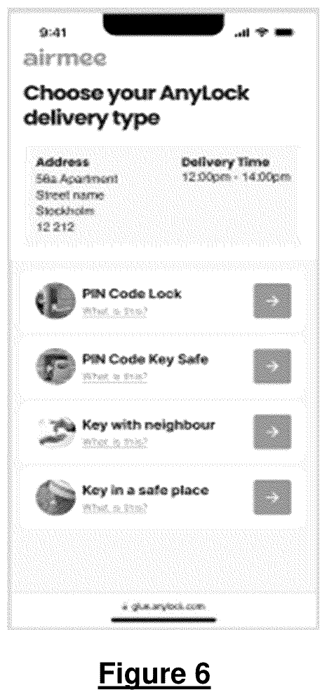

5. FIG. 6 shows a screenshot of a mobile application where the customer lands on the AnyLock web module and is presented with their delivery details as well as the option to choose a specific type of AnyLock delivery method. Glue retrieves customer and delivery details from the courier partner via API. Once the customer has landed on the AnyLock module the Glue platform ingests the tracking ID (or hash thereof) and stores it as a data item.

Glue then uses the tracking ID data item to retrieve customer and delivery details from the courier partner via an API. Upon retrieval, the data items will be stored on the Glue platform.

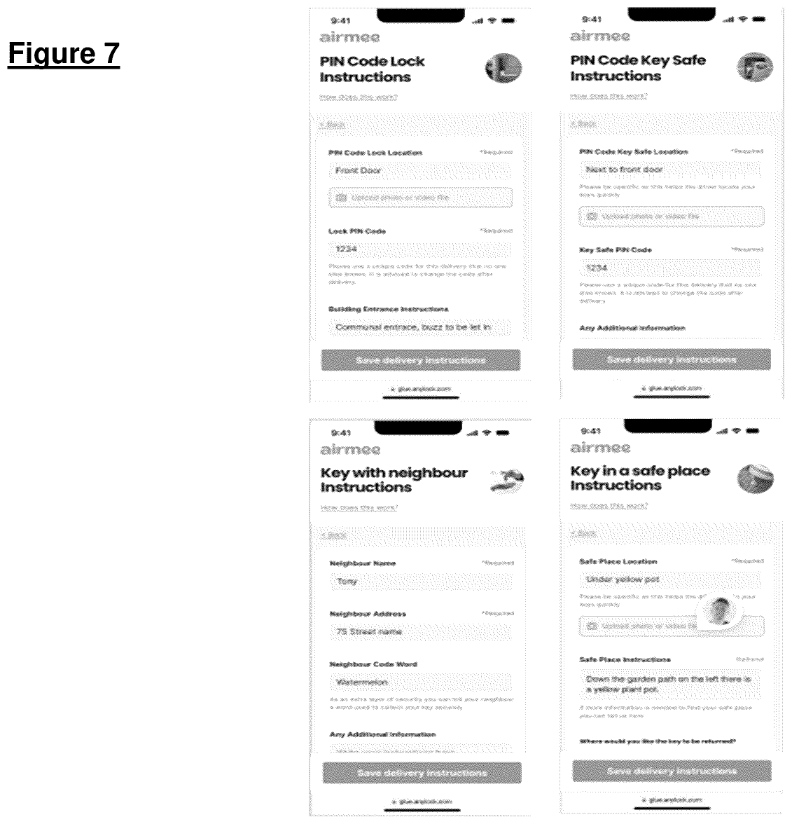

6. FIG. 7 shows screenshots from the mobile application illustrating the customer enters delivery details against one of the four AnyLock delivery methods.

The customer completes AnyLock Web Module providing delivery instructions The AnyLock module provides:
a. Further information about AnyLock and the different AnyLock delivery methods;
b. The option to choose from one of four AnyLock delivery methods;
c. The option to add the required AnyLock delivery information to enable the courier to complete the AnyLock delivery;
d. The option to confirm an AnyLock delivery; and/or
e. The option at any point to go back to a standard courier delivery

As the customer starts entering the AnyLock delivery details in the web module an AnyLock ID is created and stored on the Glue platform.

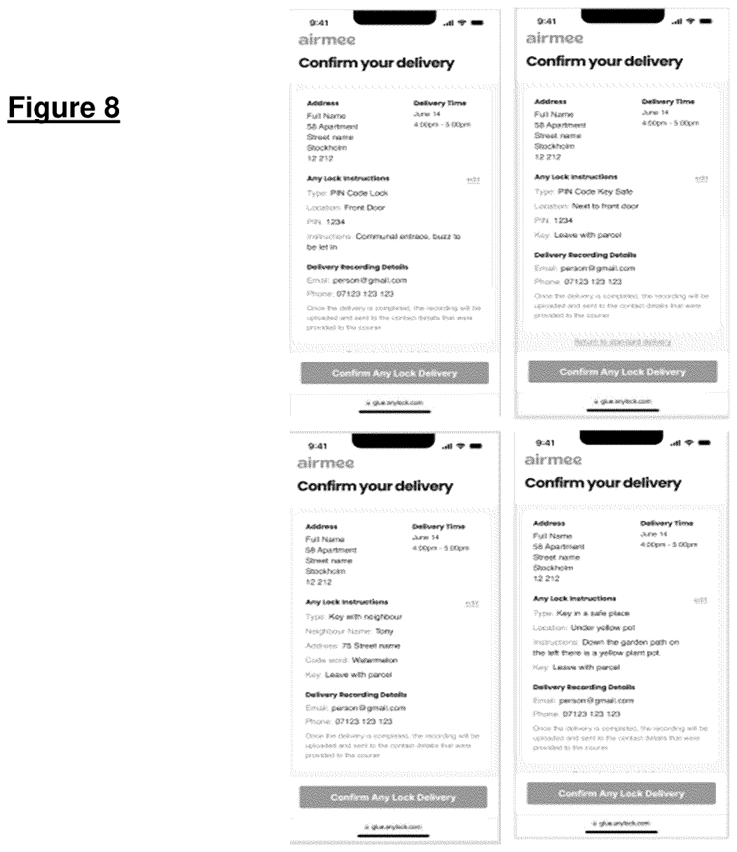

Once the customer has completed entering their details they are presented with a confirmation screen. FIG. 8 shows screenshots from the mobile application after the customer has completed AnyLock delivery details. The customer is presented with a confirmation screen.

7. The Glue platform informs the courier partner via API that the delivery is an AnyLock.

Upon completion of the AnyLock web module and confirming the AnyLock delivery, the Glue platform will communicate to the courier partner that the delivery is an AnyLock delivery via API (application programming interface).

8. The courier partner dispatches the delivery.

The courier partner dispatches the delivery in the knowledge that it is an AnyLock delivery. This is communicated to the driver by a system belonging to the courier partner.

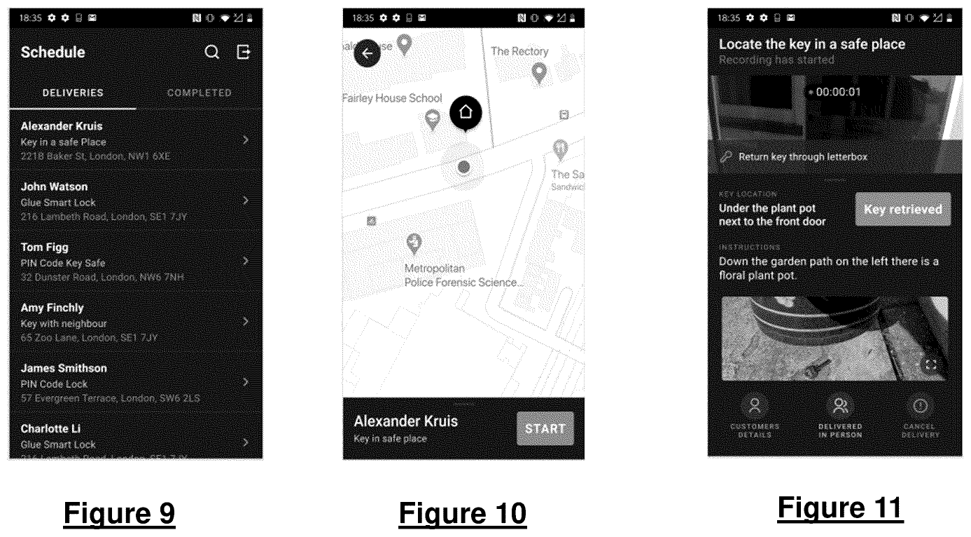

9. FIG. 9 shows a screenshot from a mobile application illustrating the courier opening the Glue Driver app and choosing the relevant delivery.

The AnyLock information is made available to the courier partner driver when they approach the property (optionally restricted to only being sent within the delivery time window). Using the knowledge conveyed in step 8, the delivery driver opens the Glue delivery driver app once they arrive at the property.

The driver app (a further mobile application) requests consent from the Glue platform to surface up the relevant data items provided in step 6 to the delivery driver.

The Glue platform validates this request by confirming that the delivery driver is requesting the information for the right customer, the right delivery and during the correct allotted delivery slot.

Another validation step is to request location services from the driver's mobile device to confirm that the delivery driver is within a predetermined distance from the location of the AnyLock delivery (e.g., using GPS or other location service). This ensures that the AnyLock delivery details are only made available to the delivery driver when they are near to the customer's address.

FIG. 10 shows a screenshot from the mobile application of the Glue platform completing verification and allowing the delivery driver to elect to start the delivery Upon successful validation, the relevant AnyLock delivery information is surfaced up to the delivery driver via the delivery app using an API.

FIG. 11 shows a screenshot of the mobile application where the delivery driver starts the delivery, video recording automatically commences and the relevant AnyLock details are surfaced.

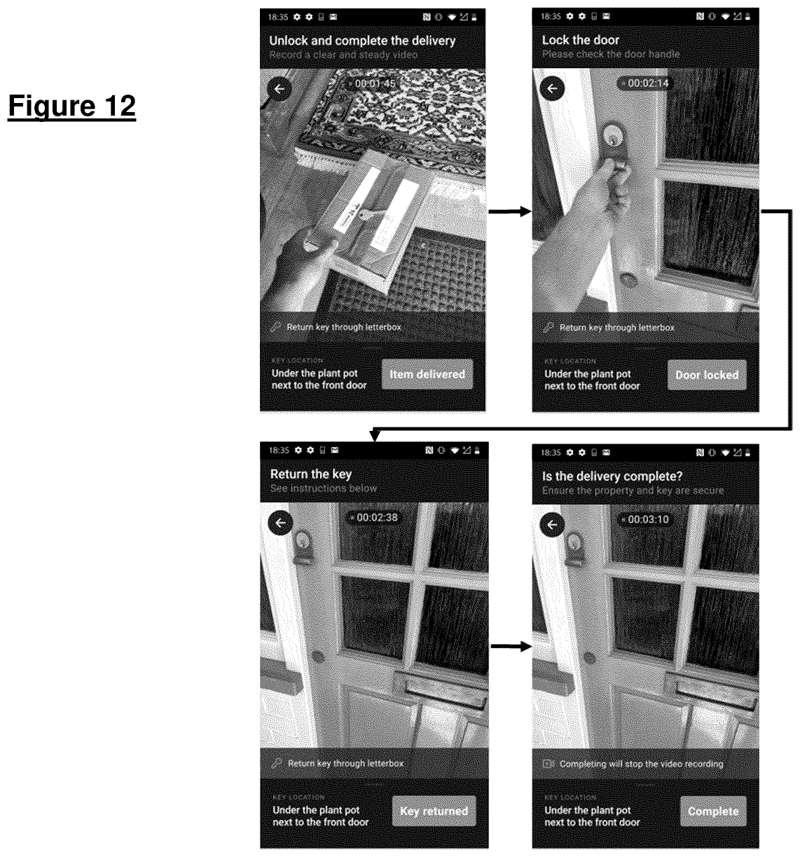

10. FIG. 12 shows a series of screenshots from the mobile application where the driver is guided through the delivery, including instructions as to where to return the key. The driver app communicates with the Glue platform to confirm a successful delivery.

The driver completes the delivery. The delivery driver completes the delivery using the AnyLock information provided. Once the delivery driver has completed the delivery (including leaving the key in the customer's desired location) the delivery driver selects an option in the app to confirm that the delivery has been completed successfully.

11. The driver app communicates to the Glue platform that the delivery has been successful. The driver app also uploads the footage of the video recorded delivery to the Glue platform. The Glue platform stores the confirmation of the successful delivery and the footage as data items against the customer's Glue AnyLock ID.

12. Glue platform deletes AnyLock sensitive information.

The Glue platform deletes AnyLock data items as per the customers election in step 6. Note that certain essential data items are retained to enable validation to allow the customer to retrieve their video recording.

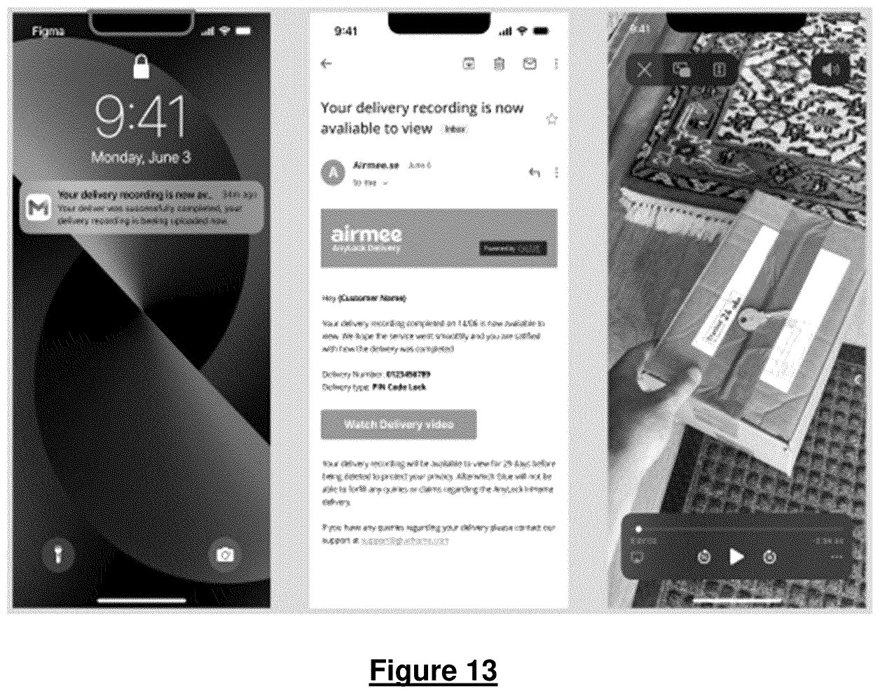

13. FIG. 13 shows a series of screenshots from the mobile application where the customer receives notification that the AnyLock delivery is complete and that they can now view the video recording of the delivery. The server (Glue) sends the customer an email/SMS with a link to view the recorded delivery and remind them to change one time codes/key locations.

Upon notification on the Glue platform that the customer has received a successful delivery confirmation, the Glue platform instructs an email platform to send a ‘successful delivery email & SMS’ notification to the customer.

The email instructs the customer that they can now view their AnyLock delivery video recording and includes a weblink to do so.

The web link directs customers to the Glue Delivery Video Viewing Module. The Delivery Video Viewing Module includes the following steps:
1. A credential check which will require the customer to enter at least two of the data items held on the Glue platform (e.g., Customer given name, Customer family name, mobile phone number, email address, tracking ID).

2. The option to view the video recording;

3. The option to provide feedback; and/or

4. The option to confirm deletion of their AnyLock data.

Note that these notifications are preferably branded as though they are from the courier.

14. The Glue platform deletes remaining AnyLock sensitive information. Once the video recording has been viewed the Glue platform deletes the remaining sensitive AnyLock data items as per the customer elections in step 6 of this process.

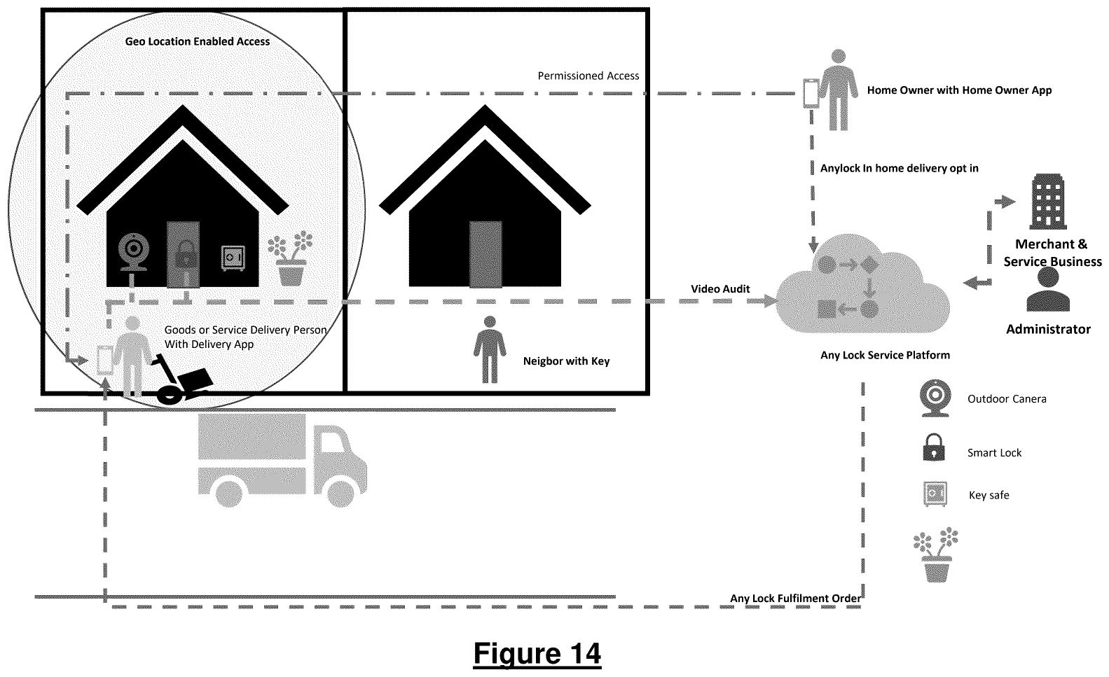

FIG. 14 shows a schematic diagram of the system for implementing the method 200.

As used throughout, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element may instead be termed a “second” element and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described throughout, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

Unless otherwise described, all technical and scientific terms used throughout have a meaning as is commonly understood by one of ordinary skill in the art to which the various embodiments described herein belongs.

As will be appreciated by the skilled person, details of the above embodiment may be varied without departing from the scope of the present invention, as defined by the appended claims.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

Please amend the presently pending claims as follows:

1. A method implemented by at least one computer for managing a secure delivery to a property, the method comprising:
as part of a transaction, receiving from a first user a selection of a courier entity;
the courier entity scheduling a delivery to the property;
providing the first user with an option for using an enhanced delivery mode;
receiving confirmation from a first user that the enhanced delivery mode is selected;
receiving from the courier entity delivery details;
receiving delivery instructions from the first user;
transmitting to the courier entity confirmation that the delivery uses the enhanced delivery mode;
detecting, using a mobile application, a location of a mobile device of a second user;
determining that the location of the mobile device is within a predetermined distance of the property;
receiving from the mobile application confirmation once the delivery to the property has been made according to the delivery instructions;
deleting a first set of sensitive data related to the property and/or the delivery;
transmitting to the user details of the delivery; and
deleting a second set of sensitive data related to the property and/or the delivery.

2. The method of claim 1, wherein the delivery details are received from the courier entity using an application programming interface API.

3. The method of claim 1, wherein the confirmation to the courier entity that the delivery uses the enhanced delivery mode is transmitted using an application programming interface API.

4. The method according to claim 1, wherein the delivery instructions received from the first user include data describing how to gain access to the property.

5. The method of claim 4, wherein the data describing how to gain access to the property include any one or more of: a PIN code for a door lock; a location of a key; and or a one-time code.

6. The method according to claim 1 further comprising transmitting to the mobile device of the second user the delivery instructions in response to determining that the location of the mobile device is within a predetermined distance of the property.

7. The method of claim 6, wherein the delivery instructions are transmitted in response to the current time being within a delivery window.

8. The method of claim 7, wherein the delivery window is defined as part of the courier entity scheduling the delivery to the property.

9. The method according to claim 1, wherein providing the first user with an option for using an enhanced delivery mode is sent using email or short message service SMS.

10. The method of claim 9, wherein the email or SMS includes a universal resource locator URL.

11. The method according to claim 1, wherein the first set of sensitive data include the delivery instructions.

12. The method according to claim 1, wherein the second set of sensitive data include the identity of the first user and/or the location of the property.

13. A system comprising:
one or more processors; and
at least one memory storing computer-executable instructions that, when executed by the one or more processors, cause the system to manage a secure delivery to a property by:
as part of a transaction, receiving from a first user a selection of a courier entity;
the courier entity scheduling a delivery to the property;
providing the first user with an option for using an enhanced delivery mode;
receiving confirmation from a first user that the enhanced delivery mode is selected;
receiving from the courier entity delivery details;
receiving delivery instructions from the first user;
transmitting to the courier entity confirmation that the delivery uses the enhanced delivery mode;
detecting, using a mobile application, a location of a mobile device of a second user;
determining that the location of the mobile device is within a predetermined distance of the property;
receiving from the mobile application confirmation once the delivery to the property has been made according to the delivery instructions;
deleting a first set of sensitive data related to the property and/or the delivery;
transmitting to the user details of the delivery; and
deleting a second set of sensitive data related to the property and/or the delivery.

14. (canceled)

15. The method of claim 2, wherein the confirmation to the courier entity that the delivery uses the enhanced delivery mode is transmitted using an API.

16. The method according to claim 2, wherein the delivery instructions received from the first user include data describing how to gain access to the property.

17. The method according to claim 2, wherein the first set of sensitive data include the delivery instructions.

18. The method according to claim 3, wherein the first set of sensitive data include the delivery instructions.

19. At least one non-transitory computer-readable medium storing instructions that, when read by one or more processors, cause the one or more processors to manage a secure delivery to a property by:
as part of a transaction, receiving from a first user a selection of a courier entity;
the courier entity scheduling a delivery to the property;
providing the first user with an option for using an enhanced delivery mode;
receiving confirmation from a first user that the enhanced delivery mode is selected;
receiving from the courier entity delivery details;
receiving delivery instructions from the first user;
transmitting to the courier entity confirmation that the delivery uses the enhanced delivery mode;
detecting, using a mobile application, a location of a mobile device of a second user;
determining that the location of the mobile device is within a predetermined distance of the property;
receiving from the mobile application confirmation once the delivery to the property has been made according to the delivery instructions;
deleting a first set of sensitive data related to the property and/or the delivery;
transmitting to the user details of the delivery; and
deleting a second set of sensitive data related to the property and/or the delivery.

20. The non-transitory computer-readable medium of claim 19, wherein:
the delivery details are received from the courier entity using an application programming interface (API); and
the confirmation to the courier entity that the delivery uses the enhanced delivery mode is transmitted using an API.

21. The non-transitory computer-readable medium of claim 19, wherein:
the data describing how to gain access to the property include any one or more of: a PIN code for a door lock; a location of a key; and or a one-time code;
the instructions further cause the one or more processors to transmit to the mobile device of the second user the delivery instructions in response to determining that the location of the mobile device is within a predetermined distance of the property; and
the delivery instructions are transmitted in response to the current time being within a delivery window.
